(19) United States
(12) Patent Application Publication
(10) Pub. No.: US 2024/0330239 A1
(43) Pub. Date: Oct. 3, 2024

(54) INFORMATION PROCESSING SYSTEM, NON-TRANSITORY COMPUTER READABLE MEDIUM, AND METHOD

(71) Applicant: FUJIFILM Business Innovation Corp., Tokyo (JP)

(72) Inventors: Kosuke Kikushima, Kanagawa (JP); Toshiyuki Komoda, Kanagawa (JP); Itsusei Matsushita, Kanagawa (JP); Koji Bito, Kanagawa (JP); Jun Ohashi, Kanagawa (JP); Daiki Matsuoka, Kanagawa (JP)

(73) Assignee: FUJIFILM Business Innovation Corp., Tokyo (JP)

(21) Appl. No.: 18/460,574

(22) Filed: Sep. 3, 2023

(30) Foreign Application Priority Data
Mar. 29, 2023 (JP) 2023-052771

(51) Int. Cl. G06F 16/11; G06F 16/176

(52) U.S. Cl. CPC G06F 16/122; G06F 16/1774

(57) ABSTRACT

An information processing system includes one or more processors configured to: when a series of processes on a file are defined in advance, the series of processes including a first process and a second process, the second process being performed after execution of the first process, arrange a first request unit and a second request unit on a display unit in this sequence, the first request unit being used to request the first process, the second request unit being used to request the second process; and, after the first process is requested by using the first request unit, until the second process is requested by using the second request unit, exert control related to a user operation on the basis of the second process.

### CROSS-REFERENCE TO RELATED APPLICATIONS

This application is based on and claims priority under 35 USC 119 from Japanese Patent Application No. 2023-052771 filed Mar. 29, 2023

### BACKGROUND

### (i) Technical Field

The present disclosure relates to an information processing system, a non-transitory computer readable medium, and a method.

### (ii) Related Art

Japanese Unexamined Patent Application Publication No. 2015-119251 describes information equipment including a failure detection unit, a workflow continuing unit, and a data storage unit. After a workflow begins, in execution of each processing program, the failure detection unit detects whether a failure for the process is present. When presence of a failure is detected, the workflow continuing unit executes, instead of the processing program whose execution the failure interferes with, an alternative program, which is a processing program having a similar function, to continue the operation of the workflow. When presence of a failure is detected, the data storage unit stores data obtained as a processing result by using a processing program executed before execution of the alternative program.

Japanese Unexamined Patent Application Publication No. 2020-106993 describes an information processing system including a support information presentation unit which presents support information for supporting setting of a first workflow, on the basis of the history of execution of the first workflow.

Japanese Unexamined Patent Application Publication No. 2019-153930 describes an information processing apparatus which controls execution of a workflow including one or more processes selected by a user. The information processing apparatus includes a holding unit and a process-setting changing unit. The holding unit holds setting information for setting processes which are controlled so that the processes are not performed in a workflow. The process-setting changing unit changes settings for a workflow so that the processes which are set in the setting information are not performed.

For example, predetermined processes may be performed in predetermined order as a series of processes performed on a file. In this case, the following form is assumed: multiple request buttons for requesting execution of the predetermined processes are arranged in the predetermined order, and a user operates the request buttons sequentially to execute the series of processes.

Some user operation, which is received in the middle of the series of processes, may cause execution of a subsequent process to fail due to influence of the user operation.

### SUMMARY

Aspects of non-limiting embodiments of the present disclosure relate to suppression of influence on a subsequent process which is caused by a user operation performed in the middle of a series of processes performed on a file.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising: one or more processors configured to: when a series of processes on a file are defined in advance, the series of processes including a first process and a second process, the second process being performed after execution of the first process, arrange a first request unit and a second request unit on a display unit in this sequence, the first request unit being used to request the first process, the second request unit being used to request the second process; and, after the first process is requested by using the first request unit, until the second process is requested by using the second request unit, exert control related to a user operation on a basis of the second process.

### BRIEF DESCRIPTION OF THE DRAWINGS

Exemplary embodiment of the present disclosure will be described in detail based on the following figures, wherein:

FIG. 1 is a diagram illustrating an exemplary entire configuration of an information processing system to which the present exemplary embodiment is applied;

FIG. 2 is a diagram illustrating an exemplary hardware configuration of a management server and a user terminal according to the present exemplary embodiment;

FIG. 3 is a diagram illustrating an exemplary functional configuration of a user terminal according to the present exemplary embodiment;

FIG. 4 is a diagram illustrating an exemplary functional configuration of a management server according to the present exemplary embodiment;

FIG. 5 is a diagram for describing management of processing information, which is performed by a processing-information management unit according to the present exemplary embodiment;

FIG. 6 is a diagram illustrating exemplary display, on a display unit, to which the present exemplary embodiment is applied;

FIG. 7 is a diagram illustrating an exemplary toolbar to which the present exemplary embodiment is applied;

FIG. 8 is a diagram for describing a first exemplary user operation which affects a subsequent process;

FIG. 9 is a diagram for describing a second exemplary user operation which affects a subsequent process;

FIG. 10 is a diagram illustrating an exemplary control process related to a user operation; and

FIG. 11 is a diagram illustrating an exemplary control process related to a user operation.

### DETAILED DESCRIPTION

Referring to the attached drawings, an exemplary embodiment of the present disclosure will be described in detail below.

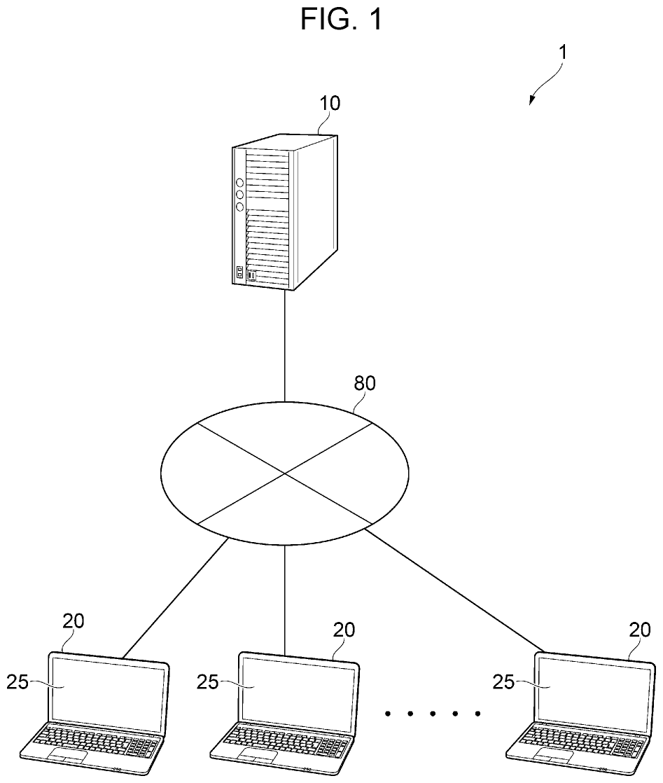

FIG. 1 is a diagram illustrating an exemplary entire configuration of an information processing system 1 to which the present exemplary embodiment is applied.

In the information processing system 1 according to the present exemplary embodiment, a management server 10, which manages files of users, and user terminals 20, which are operated by the users, are connected to each other through a communication line 80. The communication line 80, which is, for example, a line such as the Internet, is used for information communication between the management server 10 and the user terminals 20.

In the present exemplary embodiment, a “file” refers to an electronic file stored, for example, in the management server 10. The file includes image data, movie data, audio data, text data, programs, or a combination of at least two of these. In addition, the file may include attribute information, such as the creation date and time of the file, the update date and time, the author, the editor, the sheet size, the number of pages, the format, the file name, and keywords in the file. The file format is not limited to a particular format. However, the file format managed by the management server 10 may be limited.

The management server 10 according to the present exemplary embodiment is an information processing apparatus which provides a service for managing files (hereinafter referred to as “file management service”). For example, as a file management service, the management server 10 provides a storage location for storing a file. The stored file may be shared with a user different from a user who has transmitted a storage request. In addition, for example, as the file management service, the management server 10 performs a process for a command which is allowed to be executed on the stored file.

The information processing system 1 illustrated in FIG. 1 includes a single management server 10. Alternatively, the information processing system 1 may include multiple servers. In addition, the management server 10 may be configured as a so-called cloud server, or may be configured as an on-premises server.

The user terminals 20 according to the present exemplary embodiment are apparatuses operated by users to perform processes on files. The user terminals 20 each include a display unit 25 formed, for example, of a liquid-crystal display panel or an organic light-emitting diode (OLED) display panel which displays, for example, images or text information for the corresponding user. The user terminal 20 are implemented, for example, by using computers, tablet information terminals, smartphones, gaming machines, and other information processing apparatuses.

The configuration of the information processing system 1 is exemplary. The configuration may be any as long as the entire information processing system 1 has functions for implementing the processes described above. Thus, some or all of the functions for implementing the processes may be assigned inside the information processing system 1, or may be operated cooperatively. In other words, the user terminals 20 may take in charge of some or all of the functions of the management server 10, or the management server 10 may take in charge of some or all of the functions of the user terminals 20. Further, some or all of the functions of each of the management server 10 and the user terminals 20 which are included in the information processing system 1 may be delegated, for example, to a different server (not illustrated). Thus, the processes of the entire information processing system 1 are facilitated, and may complement each other.

In the description below, assume the case in which a user, who uses the file management service by using a user terminal 20, requests execution of processes, which are predetermined as a series of processes, on a file in predetermined order by using request buttons for requesting the processes. “A series of processes” refers to multiple predetermined processes performed on a file in predetermined order. For a series of processes, a user sets, for example, the content of the processes and the order of execution of the processes.

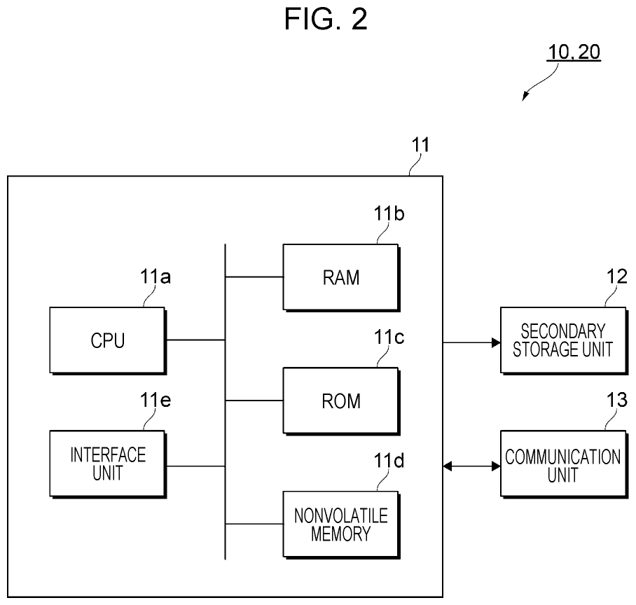

FIG. 2 is a diagram illustrating an exemplary hardware configuration of the management server 10 and each user terminal 20 according to the present exemplary embodiment.

Each of the management server 10 and the user terminals 20 includes a controller 11 that controls the operation of the entire apparatus, a secondary storage unit 12 in which various types of information are recorded, and a communication unit 13 that receives/transmits information through the communication line 80 (see FIG. 1). The controller 11, the secondary storage unit 12, and the communication unit 13 are connected through a bus or a signal line.

The controller 11 includes a central processing unit (CPU) 11a that is an exemplary processor and that controls the entire apparatus, a random-access memory (RAM) 11b that is used, for example, as a work memory of the CPU 11a, and a read-only memory (ROM) 11c that stores, for example, programs executed by the CPU 11a. The controller 11 also includes a nonvolatile memory 11d that is rewritable and that is capable of holding data even when power supply stops, and an interface unit 11e that controls the units such as the communication unit 13 connected to the controller 11.

The nonvolatile memory 11d is formed, for example, of a battery-backed static random access memory (SRAM) or a flash memory. The controller 11 reads programs stored in the secondary storage unit 12, and thus causes the corresponding apparatus according to the present exemplary embodiment to perform processes.

The secondary storage unit 12 is formed, for example, of a hard disk drive (HDD) or a semiconductor memory. The secondary storage unit 12 is different depending on the product form of the apparatus, The secondary storage unit 12 stores programs executed by the controller 11 and various types of information.

Other than these, each user terminal 20 includes an input device (not illustrated), such as a keyboard and a mouse, and the display unit 25 (see FIG. 1) formed, for example, of a liquid-crystal display. When the input device of a user terminal 20 is a touch panel, the input device may be integrated with the display unit 25.

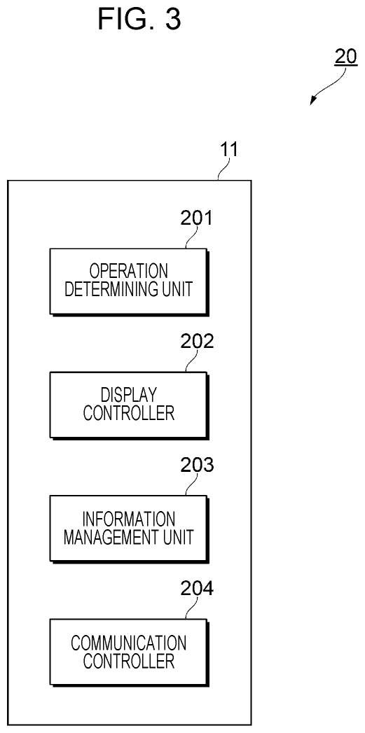

FIG. 3 is a diagram illustrating an exemplary functional configuration of each user terminal 20 according to the present exemplary embodiment. Most of the functions of the user terminal 20 illustrated in FIG. 3 are implemented by the CPU 11a (see FIG. 2) of the controller 11.

As illustrated in FIG. 3, the user terminal 20 includes an operation determining unit 201 that determines operations performed by a user, a display controller 202 that controls display on the display unit 25 (see FIG. 1), an information management unit 203 that manages various types of information, and a communication controller 204 that controls communication through the communication unit 13 (see FIG. 2).

The operation determining unit 201 determines whether an operation has been performed on the user terminal 20, for example, through the input device. This operation is an operation of entering a request to the user terminal 20 or the server 10, such as an operation of transmitting a request to set or perform various processes on a file or an operation of transmitting a request related to viewing of a file. In accordance with an operation performed, for example, through the input device, the operation determining unit 201 generates request information indicating a request from a user, and makes the generated request information available to the user terminal 20 or the server 10.

The display controller 202 controls, for example, the display form on the display unit 25. For example, the display controller 202 controls the display form of a screen and the like in use of the file management service.

The information management unit 203 manages information about files. Specifically, in the file management service, the information management unit 203 manages information used in use of services for performing processes on files. Examples of information managed by the information management unit 203 include information about files themselves, attribute information of the files, information indicating the content of processes on the files, and information indicating settings for a series of processes.

The communication controller 204 processes information transmitted by the communication unit 13, and processes received information. Specifically, the communication controller 204 transmits request information to the management server 10 (see FIG. 1) through the communication unit 13, and extracts necessary information from information transmitted from the management server 10 through the communication unit 13. The communication controller 204 processes obtained information for determination.

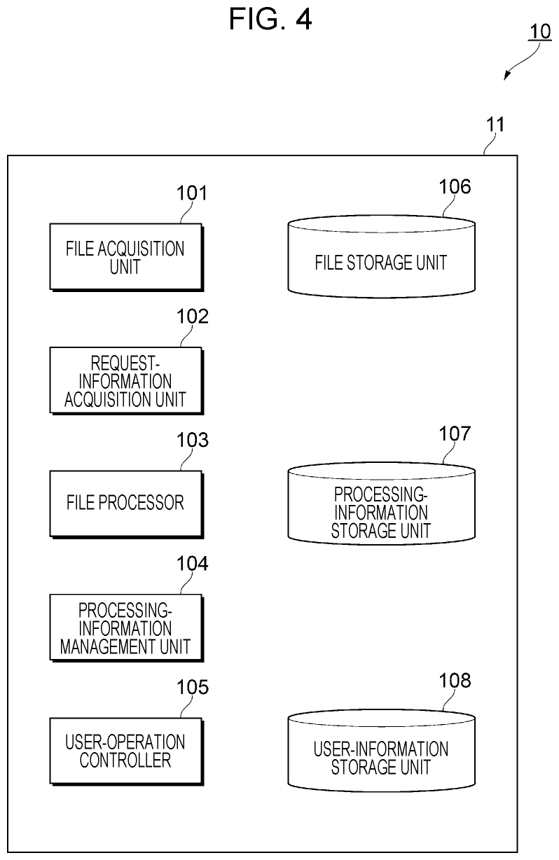

FIG. 4 is a diagram illustrating an exemplary functional configuration of the management server 10 according to the present exemplary embodiment. Most of the functions of the management server 10 illustrated in FIG. 4 are implemented by the CPU 11a (see FIG. 2) of the controller 11.

As illustrated in FIG. 4, the management server 10 includes a file acquisition unit 101 that acquires information about files, a request-information acquisition unit 102 that acquires request information, a file processor 103 that performs processes on files, a processing-information management unit 104 that manages processing information which describes the processes, and a user-operation controller 105 which exerts control related user operations on the user terminals 20. The management server 10 also includes a file storage unit 106 that stores information about files, a processing-information storage unit 107 that stores the processing information, and a user-information storage unit 108 that stores user information which describes users using the file management service.

The file acquisition unit 101 acquires information about files, such as the content of the files themselves and attribute information of the files. Specifically, the file acquisition unit 101 acquires information about files from various types of information received from other apparatuses and various types of information stored in the secondary storage unit 12 (see FIG. 2) of the management server 10. Examples of other apparatuses include the user terminals 20 (see FIG. 1). The file acquisition unit 101 stores, in the file storage unit 106, acquired information about files.

The request-information acquisition unit 102 acquires request information from the user terminals 20. Specifically, the request-information acquisition unit 102 acquires, through the communication line 80, request information generated by the user terminals 20 in accordance with operation inputs from users. The method in which the request-information acquisition unit 102 acquires request information is not limited to the method described above.

The file processor 103 executes commands which are exemplary functions which are allowed to be executed on files. Specifically, the file processor 103 performs processes on files acquired by the file acquisition unit 101. For example, the file processor 103 performs document processing, such as editing a file, outputting a file, and identifying a file or a folder which is a storage location of a file.

The term, “editing a file”, refers to a process of changing the file body, attribute information of the file, or the data format. Editing a file body encompasses editing the content of the file body and editing an annotation added to the file body. Editing the content of a file body encompasses change, addition, or deletion of text data or the like of the file body. Editing an annotation encompasses addition of the annotation to the file body and change or deletion of the annotation added to the file body. The concept of editing a file body also encompasses dividing a single file into multiple files on a page-by-page basis, binding multiple files into one file, rotating the file, compressing the file data, and encrypting the file.

The term, “outputting a file”, refers to sharing the file data including image data of the file body. Through sharing file data, for example, an image forming apparatus prints the file, or the file is transmitted by electronic mail or facsimile.

The term, “identifying a file or a folder”, refers to searching the file storage unit 106 for the file or the folder which satisfies a condition. For example, a condition related to characters included in the name, the data format, or the author is provided. A screen, on which a user is prompted to select a file (hereinafter may be referred to as a “target file”) which is a target of a subsequent process, may be displayed in the middle of a series of processes.

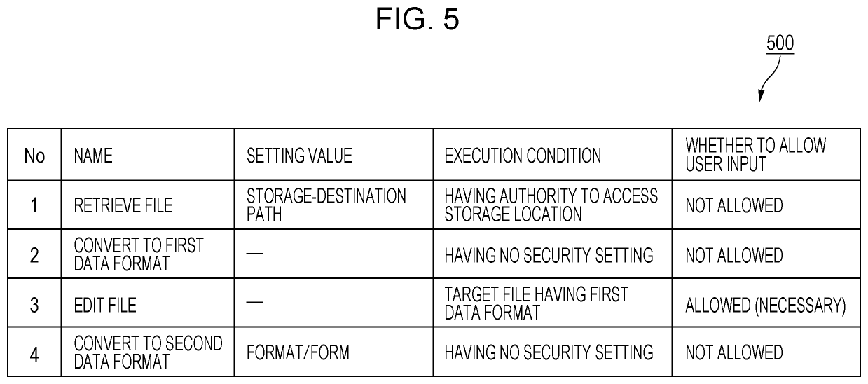

The processing-information management unit 104 manages processing information of processes performed by the file processor 103. Specifically, the processing-information management unit 104 manages the types or classifications of the processes, the content of the processes, and detailed settings of the processes. In addition, the processing-information management unit 104 manages processing information, such as conditions of files under which the processes are performed (hereinafter referred to as “execution conditions”) and information indicating whether execution of a user operation is allowed (which will be described below in detail by using FIG. 5). The processing information managed by the processing-information management unit 104 includes processing information of the processes which is settable in a series of processes.

FIG. 5 is a diagram for describing management of the processing information performed by the processing-information management unit 104 according to the present exemplary embodiment.

As illustrated in FIG. 5, the processing-information management unit 104 according to the present exemplary embodiment manages the processing information as a management table 500. In the illustrated management table 500, “name”, “setting value”, “execution condition”, “whether to allow user input” are managed as the processing information. “Name” indicates a name which is set in advance in accordance with the content of the process, and, for example, is used to generate a processing button described below. “Setting value” indicates a value for setting details of the process. Examples of “setting value” include a path, which specifies the storage location and which is used in a retrieval process of retrieving a file from the storage location, and information which specifies the format/form of a converted file and which is used in a conversion process of converting the data format. “Execution condition” indicates, as described above, a condition of a file under which the process is performed. “Execution condition” is, for example, information for specifying an attribute of a file on which the process is executable, such as whether a security restriction is present.

“Whether to allow user input” indicates whether to receive various user operations in execution of the corresponding process. More specifically, “whether to allow user input” indicates whether to receive a user operation for performing a process, which is not set in advance in a series of processes, in execution of the corresponding process in the series of processes. More specifically, “whether to allow user input” indicates whether to receive a user operation for performing a process different from the process requested in response to selection of a processing button described below. Hereinafter, a process which is not set in advance in a series of processes and which is different from the process requested in response to selection of a processing button may be called an “optional process”. A concrete example of an optional process will be described below.

In addition, a user operation for performing an optional process may be performed, not only in execution of a process in a series of processes, but also between a certain process and the next process, in other words, between completion of the certain process and selection of the processing button corresponding to the next process.

Referring to FIG. 4 again, the processing-information management unit 104 manages processing information for a series of processes. Specifically, the processing-information management unit 104 manages, as processing information for a series of processes, information indicating the content of the processes and the order of execution of the processes.

In addition, the processing-information management unit 104 stores, in the processing-information storage unit 107, processing information in association with image data indicating corresponding processes. Then, the processing-information management unit 104 provides the image data, indicating the processes, to the user terminals 20 through the communication unit 13 (see FIG. 2).

The user-operation controller 105 exerts control related to user operations received by the user terminals 20. More specifically, the user-operation controller 105 exerts control related to user operations which are different from those indicated by selection of processing buttons 271 and which are performed in the middle of a series of processes. The details, such as concrete examples of the user operations, the condition under which control related to the user operations is exercised, and specific content of the control related to the user operations, will be described in detail below.

The file storage unit 106 stores and accumulates information about files, which are acquired by the file acquisition unit 101, or files having been processed by the file processor 103.

The processing-information storage unit 107 stores information about processes performed by the file processor 103. Specifically, the processing-information storage unit 107 stores processing information and image data, which are managed by the processing-information management unit 104, and information indicating points such as stop points managed by the user-operation controller 105.

The user-information storage unit 108 stores user information of users using the file management service. The user information includes, for example, information, which enables users to be identified, such as user names.

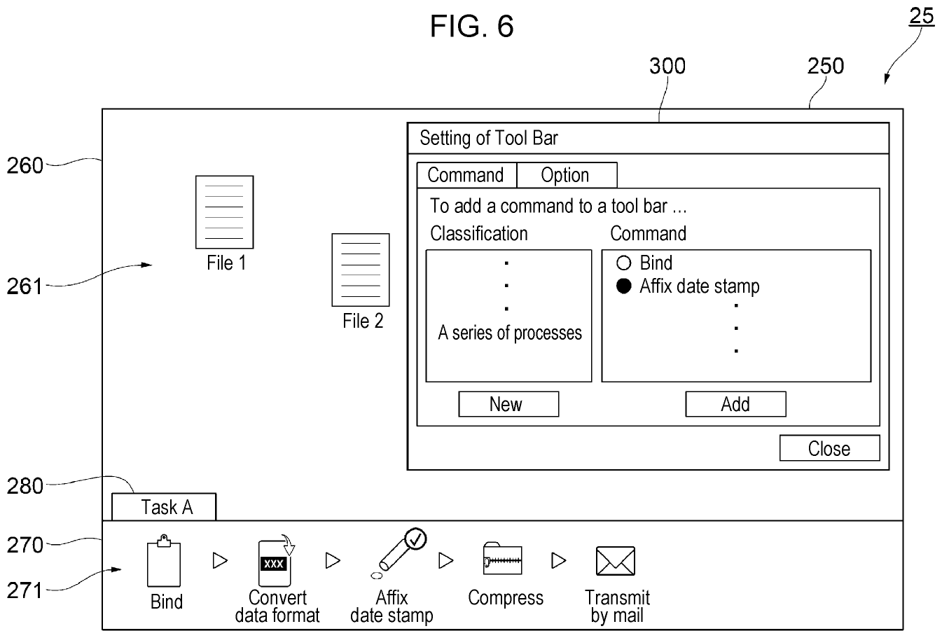

FIG. 6 is a diagram illustrating exemplary display on the display unit 25 to which the present exemplary embodiment is applied.

In the example in FIG. 6, the display unit 25, to which the present exemplary embodiment is applied, displays an operation screen 250 for receiving operations from a user who uses the file management service. The operation screen 250 includes a workspace 260 on so-called file handling software and a toolbar 270 for illustrating commands on a file. The file handling software is software for managing digitized files, and has a function of promoting integrated management of paper and digitized files. On the operation screen 250, a toolbar setting screen 300 for receiving settings of the toolbar 270 from a user is displayed.

A pointer image which moves in accordance with an operation performed by a user using a mouse or the like may be displayed on the operation screen 250.

The workspace 260 is an area in which, for example, file icons 261 corresponding to files and representing the files are displayed. In the example in FIG. 6, various file icons 261 provided for corresponding files are displayed. The files corresponding to the file icons 261 are, for example, targets of the process for a command included in the toolbar 270.

The workspace 260 also serves as an area in which the content of a file is displayed when the file is used.

The toolbar 270 is an area in which information about commands that are to be executed on a file is displayed. In other words, the toolbar 270 is an area in which the flow of a series of processes performed by a user using the file management service is displayed.

In the example in FIG. 6, the workflow of a task performed by a user using the file management service is illustrated in the toolbar 270. A tab 280 indicating the name of the workflow, “task A”, is displayed in association with the toolbar 270. An area in which a workflow is displayed may be provided for each task. When multiple tasks are set, tabs 280 for the respective tasks are displayed. Each tab 280 may receive, from a user, a request to display the workflow of the corresponding task on the toolbar 270.

In the toolbar 270, button images corresponding to commands executed on a file are displayed. In the example in FIG. 6, various processing buttons 271 corresponding to the processes for commands are displayed in one direction. Specifically, in the toolbar 270, processing buttons 271 indicating the following processes are arranged and displayed as the processes, which are included in the task, in one direction (in the example in FIG. 6, the direction to the right): a binding process of binding multiple files into one file; a conversion process of converting the data format of the file to a data format such as Portable Document Format (PDF)®; an addition process of adding a date stamp as an annotation for the file body; a compression process of compressing the data of the file; and a transmission process of transmitting the file by electronic mail.

The processing buttons 271 correspond to the processes for the commands which may be set from the toolbar setting screen 300 or a menu bar (not illustrated). The processing buttons 271 are displayed in a state in which the processes for the commands may be identified individually. The processing button 271 each are formed, for example, of an image or a text which indicates the content of the corresponding process. The image or the text for the corresponding processing button 271 may be changed in accordance with detailed settings of the corresponding process or in accordance with customization by a user.

The processing buttons 271 are button images which receive, from a user, requests for execution of the respective processes on a file. For example, when a processing button 271 corresponding to the process of compressing file data is selected, the process of compressing data is performed on a file. For example, a user selects a processing button 271 through operation input using an input device, such as a click.

A processing button 271 is an exemplary request unit according to the present exemplary embodiment.

The toolbar setting screen 300 receives, from a user, for example, settings of commands whose information is displayed in the toolbar 270. The toolbar setting screen 300 illustrates commands for each classification. The commands include various processes corresponding to the processing buttons 271.

In setting a command, for example, a user selects an add button in the state in which a command is specified in the toolbar setting screen 300. Thus, a request to add the command to the toolbar 270 is received. In addition, for example, a user moves a command from the toolbar setting screen 300 to the toolbar 270 by drag and drop. Thus, a request to add the command to the toolbar 270 is received. In setting a command, for example, a user may input commands in an “option” page of the toolbar setting screen 300. Thus, not only the content of the command, but also detailed settings for the command or settings of the condition or the like of a file to which the command is applied may be received.

In addition, for example, a user may select a “new” button on the toolbar setting screen 300. Thus, the toolbar setting screen 300 may receive a request to provide a new area, in which processing buttons 271 are displayed, on the operation screen 250.

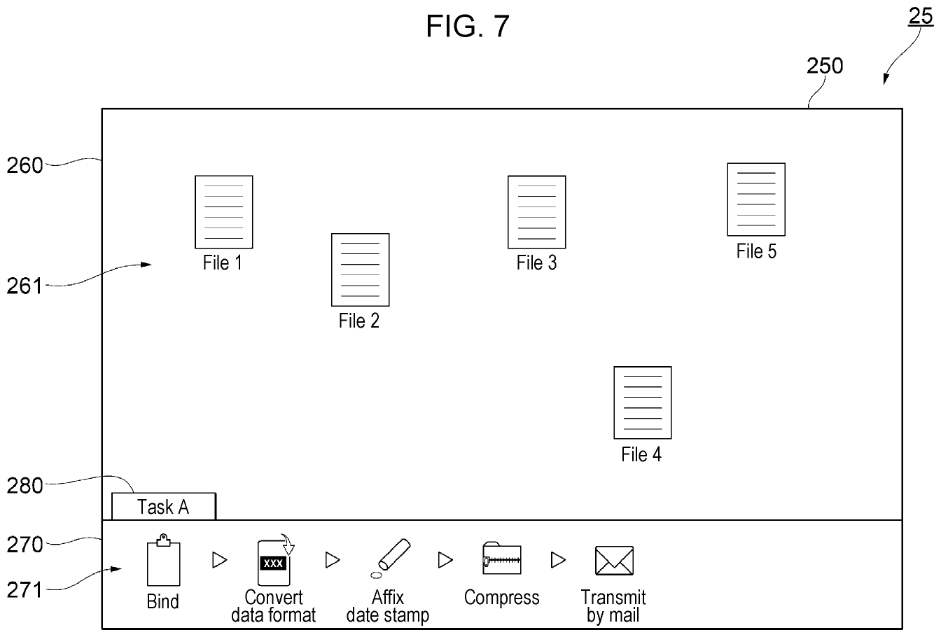

FIG. 7 is a diagram illustrating an exemplary toolbar 270 to which the present exemplary embodiment is applied.

In the example in FIG. 7, the processing buttons 271 corresponding to the processes are displayed. More specifically, the tab 280 describes a series of processes, on a file, which are set as the workflow, “task A”. In the tab 280, the processing buttons 271 corresponding to the set processes are arranged in the order corresponding to the order of the set processes, in a line to the right. In this form, the “Bind” processing button 271 disposed at the left end in the toolbar 270 is the first process in the series of processes; the “Transmit by mail” processing button 271 disposed at the right end is the last process in the series of processes.

When the toolbar 270 illustrated in FIG. 6 is used, a user selects the processing button 271 at the left end in the toolbar 270 in the state in which a target file is selected. Thus, the binding process corresponding to the processing button 271 at the left end is specified, and the binding process is performed on the target file. Then, the user selects the processing button 271 which is the second from the left in the toolbar 270. Thus, the conversion process corresponding to the second processing button 271 from the left is specified, and the conversion process is performed on the target file. Similarly, specification of a process corresponding to selection of a processing button 271 and execution of the corresponding process are repeatedly performed. When the transmission process, which is specified by selection of the processing button 271 at the right end in the toolbar 270, is performed, all the set processes are completed.

In the present exemplary embodiment, a series of processes start in response to a request for execution of the first process, and end in response to completion of execution of the last process. Accordingly, in the example in FIG. 6, the “Bind” processing button 271 at the left end is selected, and the binding process is specified. Thus, the series of processes start. The “Transmit by mail” processing button 271 at the right end is selected, and execution of the transmission process completes. Thus, the series of processes end.

### User Operation Affecting a Subsequent Process

In the middle of a series of processes, a user may perform some user operation other than selection of a processing button 271. For example, a user may perform a user operation, which is related to a target file and which is performed for execution of an optional process, during execution of a process in which user input is allowed or between processes in a series of processes, as described above by using FIG. 5.

However, depending on the content of an optional process performed in accordance with a user operation, such a user operation may affect a subsequent process. A concrete example of this may be the state in which execution of a subsequent process fails.

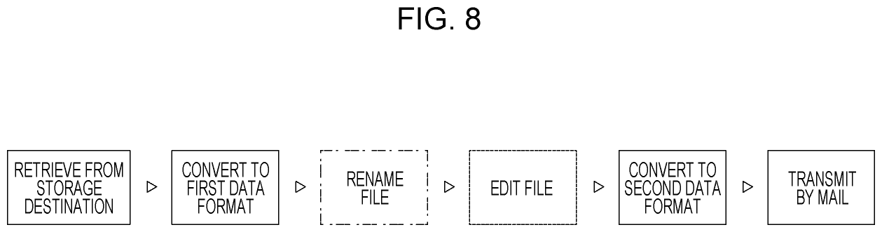

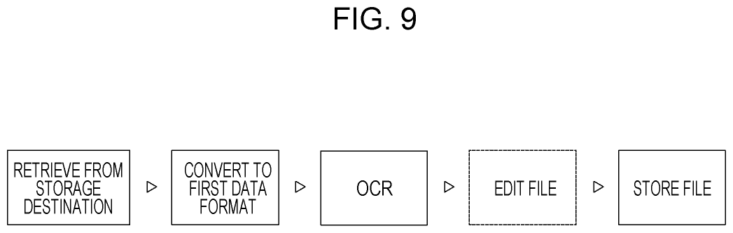

A user operation which affects a subsequent process will be described below more specifically by using FIGS. 8 and 9.

FIG. 8 is a diagram for describing a first exemplary user operation which affects a subsequent process.

FIG. 9 is a diagram for describing a second exemplary user operation which affects a subsequent process.

In FIGS. 8 and 9, rectangles with solid lines indicate the procedures of processes which are set as a series of processes. In other words, rectangles with solid lines indicate the procedures of processes corresponding to the respective processing buttons 271 which are set in the toolbar 270. A rectangle with a broken line indicates a procedure in which an optional process may be included, or, more specifically, the procedure of a process which is included in a series of processes and in which user input is allowed as described above by using FIG. 5. Further, a rectangle with a dot-and-dash line indicates a procedure added as an optional process. More specifically, a rectangle with a dot-and-dash line indicates the procedure of a process specified by a user operation performed between processes.

In the first example in FIG. 8, the following processes are set in advance in this sequence as a series of processes on a target file: a retrieval process of retrieving a file from a storage location; a first conversion process of converting the data format of the file to a first data format; an edit process of editing the content of the file body; a second conversion process of converting the data format of the file to a second data format; and a transmission process of transmitting the file by mail. As illustrated in FIG. 8, the procedure of the edit process, which is a procedure in which editing the file body in accordance with user operations is received, is a procedure in which user input is allowed. In addition, in this example, a renaming process is added as an optional process, which is added by a user operation, between the first conversion process and the edit process. The renaming process is a process of changing the file name to a string which is input by a user.

In the first example in FIG. 8, for example, as an optional process in the procedure of the edit process, security setting to a file may be performed. Security setting refers to a process of making a setting for requesting authority in various processes on a file. If security setting is performed in the procedure of the edit process, authority is requested in the second conversion process which is a subsequent process. Thus, execution of the second conversion process through selection of the corresponding processing button 271 fails. In this example, a user operation for security setting in the procedure of the edit process is an exemplary user operation which affects a subsequent process.

In the second example in FIG. 9, the following processes are set in advance in this sequence as a series of processes on a target file: a retrieval process; a first conversion process of converting the data format of the file to a first data format; an optical character recognition (OCR) process of adding, as attributes, strings, which are read from the pages of the file, to the respective pages; an edit process; and a storage process of storing the file in a storage location in accordance with the attributes added in the OCR process. As illustrated in FIG. 9, the procedure of the edit process, which is a procedure in which editing the file body in accordance with user operations is received, is a procedure in which user input is allowed.

In the second example in FIG. 9, for example, as an optional process in the procedure of the edit process, a page in the file may be deleted. Assume the case in which a string indicating the storage location of the file is described in the second page of the file and in which an attribute is added to the second page in the OCR process. If the second page of the file is deleted in the procedure of the edit process, the storage process, which is a subsequent process, fails to determine the storage location. In this example, a user operation of deleting the second page of the file in the procedure of the edit process is an exemplary user operation which affects a subsequent process.

Other than these, for example, in the first example in FIG. 8, as an optional process in the procedure of the edit process, the format of the file may be versioned up/down. Assume the case in which, as an execution condition of the second conversion process, the version of the file format is limited. If the file format is versioned up/down in the procedure of the edit process, the second conversion process, which is a subsequent process, fails to be performed. In this case, a user operation of versioning up/down the file format in the procedure of the edit process is an exemplary user operation which affects a subsequent process.

In addition, for example, in the first example in FIG. 8, the subject of a mail transmitted in the transmission process may use the file name. Assume the case in which there is limitation for characters and symbols allowed to be used in the subject name of mail. If the renaming process of changing the file name to a name containing restricted characters or symbols is performed, the transmission process, which is a subsequent process, fails to be performed. In this case, a user operation of performing such a renaming process is an exemplary user operation which affects a subsequent process.

Thus, depending on the content of a user operation performed in the middle of a series of processes, the execution condition of a subsequent process may fail to be satisfied, causing failure of execution of the subsequent process. “Failure of execution” refers to, not only failure of execution of the entire process, but also the case of execution of a process, which is different from the process that is to be performed in response to selection of a processing button 271 when such a user operation is not performed, or the case of execution of a process different from the process corresponding to the selected processing button 271. In other words, “failure of execution” encompasses the case in which the original process corresponding to a processing button 271 is not performed.

A series of processes and user operations described above are exemplary, and the configuration is not limited to these.

### Control Related to User Operation

In the information processing system 1 according to the present exemplary embodiment, the server 10 exerts control related to user operations on the user terminals 20. Thus, influence on a subsequent process due to a user operation performed in the middle of a series of processes on a file is suppressed.

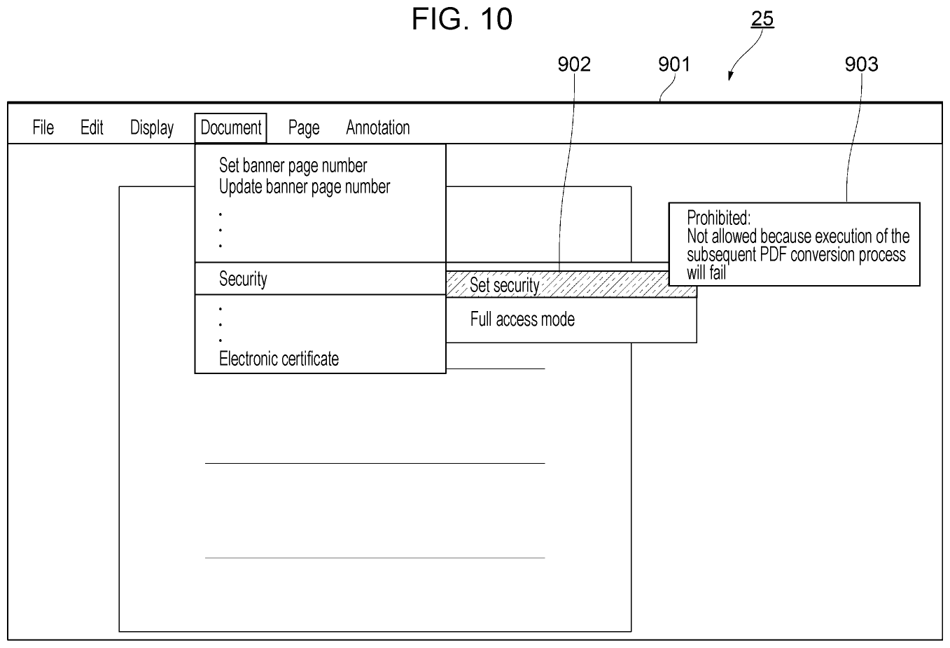

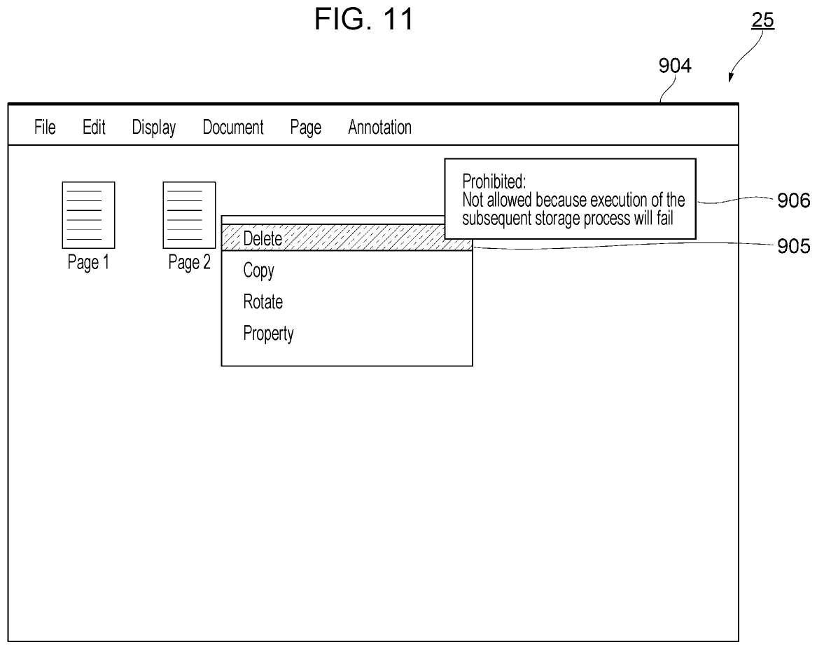

Control related to user operations will be described below more specifically by using FIGS. 10 and 11.

FIG. 10 is a diagram illustrating an exemplary process of control related to a user operation.

In the example in FIG. 10 which illustrates exemplary control related to a user operation, in the procedure of the edit process in the first example described by using FIG. 8, security setting is prohibited and a message that execution of the second conversion process (in the example in FIG. 10, the conversion process to PDF) will fail if security setting is made is notified. More specifically, on an edit screen 901 which is used to edit a file and which is displayed on the display unit 25 of a user terminal 20 in the procedure of the edit process, control is exerted so that a setting button 902 for security setting is grayed out and a user operation for security setting is not received. In addition, control is exerted so that a message 903, “Not allowed because execution of the subsequent PDF conversion process will fail”, is displayed.

Thus, a user is not able to perform a user operation for security setting. Therefore, the state in which execution of the second conversion process fails due to security setting is suppressed. In addition, display of the message 903 enables the user to grasp the reason why security setting is prohibited.

FIG. 11 is a diagram illustrating an exemplary process of control related to a user operation.

In the example in FIG. 11 which illustrates exemplary control related to a user operation, in the procedure of the edit process in the second example described by using FIG. 9, deletion of the second page of the file, to which an attribute indicating the storage location has been added, is prohibited, and a message that execution of the storage process will fail if the second page is deleted is notified. More specifically, on an edit screen 904 which is used to edit a file and which is displayed on the display unit 25 of a user terminal 20 in the procedure of the edit process, control is exerted so that a delete button 905 for deleting a page is grayed out and a user operation for deletion is not received. In addition, control is exerted so that a message 906, “Not allowed because execution of the subsequent storage process will fail”, is displayed.

Thus, a user is not able to perform a user operation for deletion of the second page of the file. Therefore, the case in which execution of the storage process fails due to the deletion is suppressed. In addition, display of the message 906 enables the user to grasp the reason why deletion of the second page of the file is prohibited.

Alternatively, as control related to a user operation, in the examples in FIGS. 8 and 10, the message 903 may be replaced with asking if a user operation for security setting is to be performed even when execution of the second conversion process (in the example in FIG. 10, the conversion process to PDF) will fail. For example, a message such as “Warning: the subsequent PDF conversion process will fail. Continue the operation?” may be displayed, and buttons for confirming a user's intention, such “Yes”/“No”, are provided. Only if “Yes” is selected, a user operation for security setting may be received. In this case, since execution of the subsequent second conversion process will fail, the series of processes may end, or, without execution of the second conversion process, the processes subsequent to the second conversion process may be performed. In the examples in FIGS. 8 and 10, without execution of the PDF conversion process, the transmission process may be performed.

Similarly, in the examples in FIGS. 9 and 11, the message 906 may be replaced with asking if a user operation of deleting the second page is to be performed even when execution of the storage process will fail.

In the examples in FIGS. 8 and 10, even in the stage of the second conversion process, security setting similar to that in the stage of the edit process may be received. In this case, security setting may be prohibited in the stage of the edit process, and a message that security setting is allowed in the subsequent second conversion process may be notified. Thus, a user operation which affects a subsequent process may be prohibited, and a different user operation which does not cause failure of execution of a subsequent process may be presented on a display unit.

In addition, when a different user operation is presented and a user performs the different user operation, a series of processes may be modified so that the series of processes includes the presented user operation.

In the examples in FIGS. 8 and 10, after security setting is made in the stage of the edit process, details setting for permitting the second conversion process (in the example in FIG. 10, the conversion process to PDF) may be made as an additional user operation. In this case, as control related to a user operation, for example, in addition to the message 903 that execution of the second conversion process will fail, a message that execution of the second conversion process is allowed if the additional user operation is performed to permit the second conversion process may be presented.

Further, a predetermined user operation in a certain process may be set as an execution condition for a subsequent process. For example, when a process (called an “extraction process”) of extracting only pages, to which annotations have been added, from a file is present as a subsequent process of the edit process, the extraction process may have an execution condition that annotations have been added to the file in the stage of the edit process. In this case, as control related to a user operation in the stage of the edit process, a prompt for addition of annotations may be notified.

### Others

The processes performed by the information processing system according to the exemplary embodiments are, for example, prepared as programs such as application software. The programs executed by the CPU 11a (see FIG. 2) which serves as an exemplary processor in the exemplary embodiments may be provided in the state in which the programs are stored in a computer-readable recording medium, such as a magnetic recording medium (for example, a magnetic tape or a magnetic disk), an optical recording medium (for example, an optical disk), a magneto-optical recording medium, or a semiconductor memory. The programs executed by the CPU 11a may be provided by using a communication unit such as the Internet.

In the embodiments above, the term “processor” refers to hardware in a broad sense. Examples of the processor include general processors (e.g., CPU) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
one or more processors configured to:
   when a series of processes on a file are defined in advance, the series of processes including a first process and a second process, the second process being performed after execution of the first process, arrange a first request unit and a second request unit on a display unit in this sequence, the first request unit being used to request the first process, the second request unit being used to request the second process; and
after the first process is requested by using the first request unit, until the second process is requested by using the second request unit, exert control related to a user operation on a basis of the second process.
   (((2)))

The information processing system according to (((1))),
wherein the one or more processors are configured to:
   as control related to the user operation, prohibit the user operation which causes execution of the second process to fail.
      (((3)))

The information processing system according to (((2))),
wherein the one or more processors are configured to:
   as control related to the user operation, prohibit the user operation and provide, on a display unit, a notification that the user operation will cause execution of the second process to fail.
      (((4)))

The information processing system according to (((2))) or (((3))),
wherein the one or more processors are configured to:
   as control related to the user operation, prohibit the user operation and present, on the display unit, a different user operation which does not cause execution of the second process to fail.
      (((5)))

The information processing system according to (((1))),
wherein the one or more processors are configured to:
   as control related to the user operation, provide, on the display unit, a notification of a user operation which will cause execution of the second process to fail.
      (((6)))

The information processing system according to (((5))),
wherein the one or more processors are configured to:
   as control related to the user operation, provide a notification of a different user operation which will cause execution of the second process to succeed if the different user operation is performed in addition to execution of the user operation which will cause execution of the second process to fail.
      (((7)))

The information processing system according to one of (((1))) to (((6))),
wherein the one or more processors are configured to:
   present, on the display unit, a user operation which is necessary for execution of the second process.
      (((8)))

The information processing system according to (((1))),
wherein the one or more processors are configured to:
   as control related to the user operation, ask, on the display unit, whether the second process is to be deleted from the series of processes; and when the second process is to be deleted from the series of processes, receive the user operation, and, when the second process is not to be deleted, prohibit the user operation.
      (((9)))

A program causing a computer to execute a process comprising:
when a series of processes on a file are defined in advance, the series of processes including a first process and a second process, the second process being performed after execution of the first process, arranging a first request unit and a second request unit on a display unit in this sequence, the first request unit being used to request the first process, the second request unit being used to request the second process; and
after the first process is requested by using the first request unit, until the second process is requested by using the second request unit, exerting control related to a user operation on a basis of the second process.

What is claimed is:

1. An information processing system comprising:
one or more processors configured to:
when a series of processes on a file are defined in advance, the series of processes including a first process and a second process, the second process being performed after execution of the first process, arrange a first request unit and a second request unit on a display unit in this sequence, the first request unit being used to request the first process, the second request unit being used to request the second process; and
after the first process is requested by using the first request unit, until the second process is requested by using the second request unit, exert control related to a user operation on a basis of the second process.

2. The information processing system according to claim 1,
wherein the one or more processors are configured to:
as control related to the user operation, prohibit the user operation which causes execution of the second process to fail.

3. The information processing system according to claim 2,
wherein the one or more processors are configured to:
as control related to the user operation, prohibit the user operation and provide, on the display unit, a notification that the user operation will cause execution of the second process to fail.

4. The information processing system according to claim 2,
wherein the one or more processors are configured to:
as control related to the user operation, prohibit the user operation and present, on the display unit, a different user operation which does not cause execution of the second process to fail.

5. The information processing system according to claim 1,
wherein the one or more processors are configured to:
as control related to the user operation, provide, on the display unit, a notification of a user operation which will cause execution of the second process to fail.

6. The information processing system according to claim 5,
wherein the one or more processors are configured to:
as control related to the user operation, provide a notification of a different user operation which will cause execution of the second process to succeed if the different user operation is performed in addition to execution of the user operation which will cause execution of the second process to fail.

7. The information processing system according to claim 1,
wherein the one or more processors are configured to:
present, on the display unit, a user operation which is necessary for execution of the second process.

8. The information processing system according to claim 1,
wherein the one or more processors are configured to:
as control related to the user operation, ask, on the display unit, whether the second process is to be deleted from the series of processes; and
when the second process is to be deleted from the series of processes, receive the user operation, and, when the second process is not to be deleted, prohibit the user operation.

9. A non-transitory computer readable medium storing a program causing a computer to execute a process comprising:
when a series of processes on a file are defined in advance, the series of processes including a first process and a second process, the second process being performed after execution of the first process, arranging a first request unit and a second request unit on a display unit in this sequence, the first request unit being used to request the first process, the second request unit being used to request the second process; and
after the first process is requested by using the first request unit, until the second process is requested by using the second request unit, exerting control related to a user operation on a basis of the second process.

10. A method comprising:
when a series of processes on a file are defined in advance, the series of processes including a first process and a second process, the second process being performed after execution of the first process, arranging a first request unit and a second request unit on a display unit in this sequence, the first request unit being used to request the first process, the second request unit being used to request the second process; and
after the first process is requested by using the first request unit, until the second process is requested by using the second request unit, exerting control related to a user operation on a basis of the second process.
